(19) United States
(12) Patent Application Publication
(10) Pub. No.: US 2025/0358304 A1
(43) Pub. Date: Nov. 20, 2025

(54) RISK ASSESSMENT TECHNIQUES FOR CONTROLLING ACCESS TO COMPUTING SYSTEMS BASED ON LOCATION-SPECIFIC EVENT DATA

(71) Applicant: EQUIFAX INC., Atlanta, GA (US)

(72) Inventors: Derek Jones, Louisville, KY (US); Paul Disney, Louisville, KY (US); Michael Tasman, Louisville, KY (US); Ray Shraideh, Wildwood, MO (US); Jeremy Vizcarra, Louisville, KY (US); Elizabeth Spilman, Louisville, KY (US)

(21) Appl. No.: 18/668,956

(22) Filed: May 20, 2024

(51) Int. Cl. H04L 9/40

(52) U.S. Cl. CPC H04L 63/1433

(57) ABSTRACT

A system can generate a risk assessment associated with a target entity. For example, the system can receive a request for a risk indicator associated with a target entity. The system can retrieve a header record from a database where the record includes a locator and identity data. The system can query an external database associated with the locator to retrieve event data and entity identity data. The system can determine that an entity associated with the entity identity data is the target entity. The system can determine a risk indicator by applying the event data to an algorithm. The system can also transmit, to a remote computing device, a responsive message including at least the risk indicator for use in controlling access of the target entity to one or more interactive computing environments.

### TECHNICAL FIELD

The present disclosure relates generally to controlling interactions between computing systems. More specifically, but not by way of limitation, this disclosure relates to risk assessment based on location-specific event data associated with a target entity for controlling interactions between computing systems.

### BACKGROUND

Various systems use event data, such as criminal records, previous employment records, and the like to determine an amount of risk associated with an entity. To identify event data associated with the entity, systems search every name associated with the entity in every available database containing event data. These extensive searches can take significant time to complete. This leads systems relying on such event data to delay actions while waiting for the event data searches to be completed.

### SUMMARY

Various aspects of the present disclosure provide systems and methods for risk assessment using a risk indicator. The system can receive a request for a risk indicator associated with a target entity, where the target entity is associated with an identifier. In some aspects, the system can retrieve, from a database, a record associated with the target entity based on the identifier. The record can include a locator and identity data. The system can query, via an application programming interface, a first external database associated with the locator based on the identity data to retrieve one or more records including first event data and entity identity data. In some aspects, the system can further determine that an entity associated with the entity identity data is the target entity by comparing the entity identity data and the identity data associated with the target entity. The system can determine the risk indicator by applying the event data to an algorithm based on the determination that the entity is the target entity. The system can transmit, to a remote computing device, a responsive message comprising at least the risk indicator for use in controlling access of the target entity to one or more interactive computing environments.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of an operating environment in which a risk assessment computing system can be used to provide a risk assessment associated with a target entity according to some aspects of the present disclosure.

FIG. 2 is a block diagram depicting a process for generating a risk assessment associated with a target entity according to some aspects of the present disclosure.

FIG. 3 is a flow chart illustrating a method for generating a risk assessment associated with a target entity according to some aspects of the present disclosure.

FIG. 4 is a block diagram depicting an example of a computing device, which can be used to implement the embodiments described herein according to some aspects of the present disclosure.

### DETAILED DESCRIPTION OF THE INVENTION

Disclosed systems and methods relate to risk assessment techniques for controlling access to computing systems based on location-specific event data. For example, an entity may wish to control access to a secure computer system by a target entity based on a background check of the target entity. The background check can span a number of databases and can access location-based event data (e.g., records stored by a particular jurisdiction). A risk assessment computing system can retrieve and analyze the location-based event data to generate a risk indicator that is usable by the entity to control access of the target entity to the secure computer system. In another example, an entity may wish to determine access or eligibility to a position of employment for an individual or may wish to determine a degree of risk associated with entering into a business arrangement with a corporation. Controlling access to computing systems, such as providing access to a secure resource or computing environment, is important to the security of such resources and computing environments. Interactions and access can be controlled based on risk assessments using data detailing a target entity's involvement in one or more location-specific events. For example, an entity can be associated with an identifier, which can be personally identifiable information (PII), such as a name or Social Security number (SSN). Based on the identifier, a system can retrieve additional identity information associated with the entity and use that identity information to query one or more external databases. These external databases can contain event data. For example, event data can include incarceration records, court records, employment records, and the like. Event data for the entity can be stored in several separate external databases. For example, an entity can have criminal records in multiple jurisdictions. Disclosed systems and methods can interact with one or more external databases to retrieve any existing event data by querying the external databases using identity information associated with the entity. Further, disclosed systems and methods can compare identity information contained in the event data to the identity information associated with the entity to generate a confidence that the event data is associated with the entity. If the confidence is above a confidence threshold, the system can analyze the event data to generate a risk indicator and transmit the risk indicator to a requesting computing system.

Certain aspects described herein for performing risk assessments on target entities using event data associated with the target entities can improve existing systems by seamlessly retrieving event data from across external databases. Generating a risk indicator (e.g., a score indicating a degree of risk associated with allowing a target entity to access a computing environment) associated with the target entity based on event data can improve the efficiency of, for example, background check operations. Disclosed systems and methods can deliver an immediate risk indicator, or indication that no event data associated with the target entity was found, to enable the requesting system to take immediate action in granting access of the target entity to a restricted system or resource. In some examples, the risk indicator can be a numerical or binary indicator of a level of risk associated with the target entity. In other aspects, the risk indicator can indicate a lack of risk associated with a target entity (e.g., an indication that the target entity is verified or is trustworthy). In other examples, disclosed systems can provide a report including the retrieved event data to the requesting system. The requesting system can then perform independent analysis on the report to determine whether to grant access to the target entity.

In some examples, a risk assessment computing system can receive a request for a risk indicator associated with a target entity. The request can include an identifier, such as an SSN, associated with the target entity. In other examples, an identifier can be a serial number or other unique identifier of a system, organization, or individual. The risk assessment computing system can query a database based on the identifier to retrieve a record associated with the target entity. The record can include additional identity information associated with the target entity, such as a name, address, email address, date of birth, etc. The address information in the header record can include locator information, which can be current or former geographic information including a ZIP code, city and state of residence, mailing address, and the like. In some examples, the record can be a header record in a database. The header record can uniquely identify an identity and can include additional PII associated with the identity.

The risk assessment computing system can identify one or more external databases to query based on the locator information in the header records. For example, the risk assessment computing system can determine one or more counties associated with a ZIP code, a state associated with a ZIP code, or a legal jurisdiction associated with a ZIP code. The risk assessment computing system can then query the identified external databases using the retrieved identity information associated with the target entity. As an example, the risk assessment computing system can identify a county court database based on a ZIP code in the mailing address associated with the target entity. In another example, the risk assessment computing system can identify a manufacturer database based on manufacturer identification included in a serial number of a computing component.

The risk assessment computing system can then query the one or more external databases using the identity information to retrieve records associated with the target entity. In another example, the risk assessment computing system can query the one or more external databases to determine whether the one or more external databases contain records matching the identity information. The records can include event data indicative of events involving the target entity. Events for an individual can be, for example, crimes, court dates, arrest records, dates of employment, and the like. In another example, events for a system or computing component can be dates of maintenance or servicing, dates of software updates, installation dates, and the like. The external databases can be, for example, automated court reporting databases or a Sex Offender Registry. In another example, an external database can be a manufacturer or distributor database or a database configured to store information associated with the maintenance of system components.

In some aspects, the risk assessment computing system can determine that it cannot access one or the one or more external databases. In such a case, the risk assessment computing system can generate a response message to the requesting computing system indicating that further research into the target entity is needed. Once an inaccessible external database is identified, the risk assessment computing system can immediately notify the requesting computing system that more research into the target entity is needed. This obviates the need for repetitive searches and processing when the requesting computing system will need to conduct further research regardless of the results of any additional external database searches.

If a query of an accessible external database returns event data associated with the target entity, the risk assessment computing system can determine entity identity information from the event data. For example, the risk assessment computing system can use text recognition or natural language processing (NLP) to extract a name, address, date of birth, etc. from the event data. The risk assessment computing system can then compare this entity identity data with the identity data from the header record to determine a level of confidence that the entity in the event data is the target entity. If the confidence level is greater than a confidence threshold, the event data can be associated with the target entity. Event data containing entity identity information that does not match the identity information of the target entity above the confidence threshold is not included in the set of results generated by the risk assessment computing system. This ensures records associated with entities having some overlapping data (e.g., a similar or the same name) is not falsely attributed to the target entity.

After gathering event data from the one or more external databases, or confirming the event data exists in the one or more external databases, the risk assessment computing system can analyze the event data. For example, the risk assessment computing system can use text recognition or NLP to identify an event type (e.g., type of crime), an event outcome (e.g., a court finding), or other information associated with the event. In some aspects, the risk assessment computing system can apply the event data to an algorithm to determine the risk indicator. For example, an algorithm can map certain extracted event data (e.g., a crime, a sentence, a court judgement, etc.) to an associated level of severity or risk. For example, a repeated crime may be associated with greater risk than a first-time offense. In another example, a level of risk can increase with the severity of a sentence imposed for a crime.

The system can then transmit the risk indicator to a remote computing system. In some examples, this may be the system from which the risk indicator was requested. The risk indicator can be used to control access of the target entity to an interactive computing environment. For example, the risk indicator can be included in a responsive message to the request for evaluating the target entity such that the responsive message can be used to allow, challenge, or deny access to the target entity. For example, if the risk indicator is below a predefined threshold, a request by the target entity to access the interactive computing environment may be automatically denied or flagged for manual review. In some examples, the risk assessment computing system may also generate and transmit to the remote computing system, a report including the retrieved event data from the one or more external databases.

Certain aspects described herein, which can include retrieving and analyzing location-specific event data associated with target entities and providing a responsive message indicating a risk associated with the target entities based on textual analysis of the retrieved location-specific event data, can improve at least the technical fields of controlling interactions between computing environments, access control for a computing environment, or a combination thereof. For instance, by generating and transmitting the responsive message, the risk assessment computing system can cause access to a computing system to be controlled more accurately. The risk assessment computing system can use a number of methods to access and query discrete databases to retrieve event data associated with a target entity. The retrieved event data can be verified, compiled, and analyzed to generate a report and a risk indicator. The event data can be analyzed to determine a level of risk of the target entity based on location-specific event data (e.g., event type, event date, entity involvement in the event, etc.) associated with the target entity. The responsive message can include the analyzed event data and results of the analysis and may be used to more efficiently predict a risk associated with the target entity accessing a system based on past events associated with the target entity, and the responsive message can facilitate a practical application of the event data retrieval and analysis techniques described herein by facilitating control of a real-world process such as a background check. Additionally or alternatively, by using the techniques described herein, a risk assessment computing system may provide legitimate access to the interactive computing environment more efficiently and using fewer computing resources compared to other risk assessment systems or techniques. For example, the risk assessment computing system can determine a risk indicator or an actionable response message efficiently thereby reducing the (i) memory usage, (ii) processing time, (iii) network bandwidth usage, (iv) response time, and the like for controlling access to the interactive computing. Accordingly, the risk assessment computing system improves the access control for computing environment by reducing memory usage, processing time, network bandwidth consumption, response time, and the like with respect to controlling access to the interactive computing environment using at least the system architecture and techniques described herein.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

Operating Environment Example for Generating a Risk Indicator Associated with a Target Entity

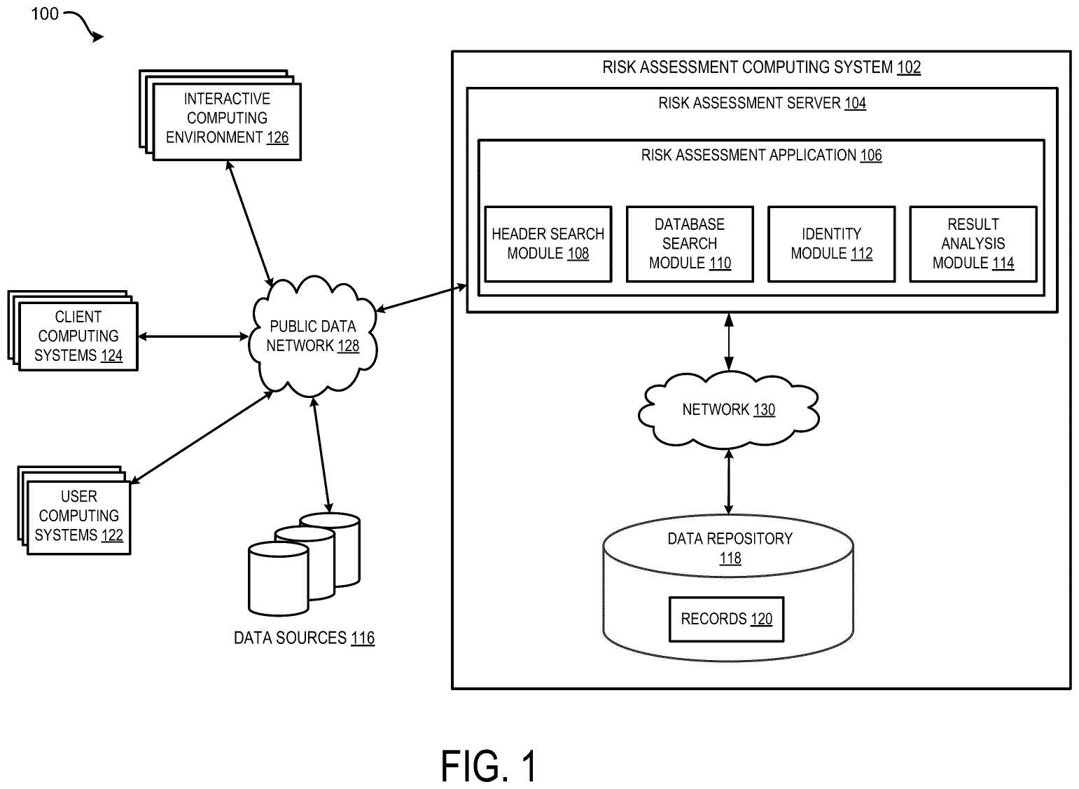

Referring now to the drawings, FIG. 1 is a block diagram depicting an example of an operating environment in which a risk assessment computing system can be used to provide a risk assessment associated with a target entity according to some aspects of the present disclosure. FIG. 1 depicts examples of hardware components of a risk assessment computing system 102, according to some aspects. The risk assessment computing system 102 can be a specialized computing system that may be used for processing large amounts of data using a large number of computer processing cycles. In other examples, the risk assessment computing system 102 may be or include a general-purpose computing system. The risk assessment computing system 102 can include a risk assessment server 104 for performing a risk assessment (e.g., predicting future risk associated with the target entity, predicting the legitimacy of the target entity, etc.) with respect to a target entity, such as a target individual or a user computing device. The risk assessment can be based on location-specific event data and can be used by a client computing system 124 to evaluate a risk associated with a target entity.

The risk assessment server 104 can include one or more processing devices that can execute program code, such as a risk assessment application 106. The program code can be stored on a non-transitory computer-readable medium or other suitable medium. The risk assessment application 106 can include one or more modules or components executing software code to complete one or more steps for determining a risk indicator. For example, the risk assessment application 106 can include: a header search module 108; a database search module 110; an identity module 112; and a result analysis module 114. The header search module 108 can retrieve a header record from the data repository 118 that includes identifying information associated with the target entity. The identifying information can include PII (e.g., name, address, date of birth, etc.) The database search module 110 can determine a locator from the identifying information and search one or more databases associated with that locator to identify records associated with the target entity. The identity module 112 can analyze the records to determine identity information contained in the records and compare this identity information with the identity information associated with the target entity to determine that the entity identified in the records is the target entity. In some aspects, the result analysis module 114 can analyze the retrieved records to determine a risk indicator associated with the target entity based on event information in the retrieved records.

The risk assessment server 104 can perform risk assessment operations or access control operations for validating or otherwise authenticating the target entity, for example using other suitable modules, models, components, etc. of the risk assessment server 104. The risk assessment server 104 can receive data associated with the target entity from external data sources 116, data repository 118, or any suitable combination thereof. In some aspects, the risk assessment application 106 can authenticate or deny a request for an interaction involving the target entity by generating a risk indicator using the target entity data retrieved from the external data sources 116 and the data repository 118.

In some aspects, the target entity data can be determined or stored in one or more network-attached storage units on which various repositories, databases, or other structures are stored. An example of these data structures can include the data repository 118. Additionally or alternatively, records 120 can be stored in the data repository 118. In some examples, the records 120 can be associated with a number of entities and can be searchable using identifying information associated with each entity. For example, the records 120 can be searched using an SSN associated with an individual, or a serial number associated with a system component. In some examples, the records 120 stored by the data repository 118 are header records.

Network-attached storage units may store a variety of different types of data organized in a variety of different ways and from a variety of different sources. For example, the network-attached storage unit may include storage other than primary storage located within the risk assessment server 104 that is directly accessible by processors located therein. In some aspects, the network-attached storage unit may include secondary, tertiary, or auxiliary storage, such as large hard drives, servers, and virtual memory, among other types of suitable storage. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

Furthermore, the risk assessment computing system 102 can communicate with various other computing systems. The other computing systems can include user computing systems 122, such as smartphones, personal computers, etc., client computing systems 124, and other suitable computing systems. For example, user computing systems 122 may transmit, such as in response to receiving input from the target entity, requests for accessing the interactive computing environment 126 to the client computing systems 124. In response, the client computing systems 124 can send authentication queries to the risk assessment server 104, and the risk assessment server 104 can receive data associated with the target entity used in the request and generate a risk indicator associated with the target entity. While FIG. 1 illustrates that the risk assessment computing system 102 and the client computing systems 124 are separate systems, the risk assessment computing system 102 and the client computing systems 124 can be one system. For example, the risk assessment computing system 102 can be a part of the client computing systems 124, or vice versa.

As illustrated in FIG. 1, the risk assessment computing system 102 may interact with the client computing systems 124, the user computing systems 122, or a combination thereof via one or more public data networks 128 to facilitate interactions between users of the user computing systems 122 and the interactive computing environment 126. For example, the risk assessment computing system 102 can facilitate the client computing systems 124 providing a user interface to the user computing system 122 for receiving various data from the user. The risk assessment computing system 102 can transmit validated risk assessment data, for example similarity-preserving hashes, comparisons or scores determined therefrom, etc., to the client computing systems 124 for providing, challenging, or rejecting, etc. access of the target entity to the interactive computing environment 126. In some examples, the risk assessment computing system 102 can additionally communicate with third-party systems to receive risk assessment data, entity data, and the like, through the public data network 128. In some examples, the third-party systems can provide real-time (e.g., streamed) data about the target entity, historical data about the target entity, etc. to the risk assessment computing system 102.

Each client computing system 124 may include one or more devices such as individual servers or groups of servers operating in a distributed manner. A client computing system 124 can include any computing device or group of computing devices operated by a seller, lender, or other suitable entity that can provide products or services. The client computing system 124 can include one or more server devices. The one or more server devices can include or can otherwise access one or more non-transitory computer-readable media.

The client computing system 124 can further include one or more processing devices that can be capable of providing an interactive computing environment 126, such as a user interface, etc., that can perform various operations. The interactive computing environment 126 can include executable instructions stored in one or more non-transitory computer-readable media. The instructions providing the interactive computing environment 126 can configure one or more processing devices to perform the various operations. In some aspects, the executable instructions for the interactive computing environment 126 can include instructions that provide one or more graphical interfaces. The graphical interfaces can be used by a user computing system 122 to access various functions of the interactive computing environment 126. For instance, the interactive computing environment 126 may transmit data to and receive data, such as via the graphical interface, from a user computing system 122 to shift between different states of the interactive computing environment 126, where the different states allow one or more electronic interactions between the user computing system 122 and the client computing system 124 to be performed.

In some examples, the client computing system 124 may include other computing resources associated therewith (e.g., not shown in FIG. 1), such as server computers hosting and managing virtual machine instances for providing cloud computing services, server computers hosting and managing online storage resources for users, server computers for providing database services, and others. The interaction between the user computing system 122, the client computing system 124, and the risk assessment computing system 102, or any suitable sub-combination thereof may be performed through graphical user interfaces, such as the user interface, presented by the risk assessment computing system 102, the client computing system 124, other suitable computing systems of the computing environment 100, or any suitable combination thereof. The graphical user interfaces can be presented to the user computing system 122. Application programming interface (API) calls, web service calls, or other suitable techniques can be used to facilitate interaction between any suitable combination or sub-combination of the client computing system 124, the user computing system 122, and the risk assessment computing system 102.

A user computing system 122 can include any computing device or other communication device that can be operated by a user or entity, such as the user entity, which may include a consumer or a customer. The user computing system 122 can include one or more computing devices such as laptops, smartphones, and other personal computing devices. A user computing system 122 can include executable instructions stored in one or more non-transitory computer-readable media. The user computing system 122 can additionally include one or more processing devices configured to execute program code to perform various operations. In various examples, the user computing system 122 can allow a user to access certain online services or other suitable products, services, or computing resources from a target entity, such as the client computing system 124, to engage in mobile commerce with the client computing system 124, to obtain controlled access to electronic content, such as the interactive computing environment 126, hosted by the client computing system 124, etc.

In some examples, the user or a target entity can use the user computing system 122 to engage in an electronic interaction with the client computing system 124 via the interactive computing environment 126. The risk assessment computing system 102 can receive a request, for example from the user computing system 122, to access the interactive computing environment 126 and can use target entity data or any other suitable data or signals determined therefrom, to determine whether to provide access, to challenge the request, to deny the request, etc. An electronic interaction between the user computing system 122 and the client computing system 124 can include, for example, the user computing system 122 being used to request a financial loan or other suitable services or products from the client computing system 124, and so on. An electronic interaction between the user computing system 122 and the client computing system 124 can also include, for example, one or more queries for a set of sensitive or otherwise controlled data, accessing online financial services provided via the interactive computing environment 126, submitting an online credit card application or other digital application to the client computing system 124 via the interactive computing environment 126, operating an electronic tool within the interactive computing environment 126 (e.g., a content-modification feature, an application-processing feature, etc.), etc.

In some aspects, an interactive computing environment 126 implemented through the client computing system 124 can be used to provide access to various online functions. As a simplified example, a user interface or other interactive computing environment 126 provided by the client computing system 124 can include electronic functions for requesting computing resources, online storage resources, network resources, database resources, or other types of resources. In another example, a website or other interactive computing environment 126 provided by the client computing system 124 can include electronic functions for obtaining one or more financial services, such as an asset report, management tools, credit card application and transaction management workflows, electronic fund transfers, etc.

A user computing system 122 can be used to request access to the interactive computing environment 126 provided by the client computing system 124. The client computing system 124 can submit a request, such as in response to a request made by the user computing system 122 to access the interactive computing environment 126, for risk assessment to the risk assessment computing system 102 and can selectively grant or deny access to various electronic functions based on risk assessment performed by the risk assessment computing system 102. Based on the request, or continuously or substantially contemporaneously, the risk assessment computing system 102 can determine one or more risk signals or risk indicators for data associated with the target entity, which may submit or may have submitted the request via the user computing system 122. The risk indicator can be based on location-specific event data retrieved from discrete databases otherwise inaccessible or inefficiently accessed by the client computing system 124. Based on a risk indicator determined from the result analysis module 114, the risk assessment computing system 102, the client computing system 124, or a combination thereof can determine whether to grant the access request of the user computing system 122 to certain features of the interactive computing environment 126. The risk assessment computing system 102, the client computing system 124, or a combination thereof can use the risk indicator for other suitable purposes such as identifying a manipulated identity, controlling a real-world interaction, and the like.

In a simplified example, the system illustrated in FIG. 1 can configure the risk assessment server 104 to be used for controlling access to the interactive computing environment 126. The risk assessment server 104 can retrieve data associated with the target entity in response to a request to access the interactive computing environment 126. The data may, for example, be retrieved based on identity information (e.g., information collected by the client computing system 124 via a user interface provided to the user computing system 122) provided by the client computing system 124 or received via other suitable computing systems. The risk assessment server 104 can retrieve the data associated with the target entity from one or more data sources 116. The data sources 116 can store, for example, event data associated with one or more events involving the target entity. The risk assessment server 104 can determine a risk indicator associated with the target entity based on an analysis (e.g., using NLP or other machine-learning techniques) of the event data. The risk assessment server 104 can transmit the risk indicator, or any inference derived therefrom, to the client computing system 124 for use in controlling access to the interactive computing environment 126.

The risk indicator associated with the target entity, or any suitable score or comparison determined therefrom, can be used, for example by the risk assessment computing system 102, the client computing system 124, etc., to determine whether the risk associated with the target entity accessing a good or a service provided by the client computing system 124 using exceeds a threshold, thereby granting, challenging, or denying access by the target entity to the interactive computing environment 126. For example, if the risk assessment computing system 102 determines that the risk indicator indicates that risk associated with the identity element is lower than a threshold value, then the client computing system 124 associated with the service provider can generate or otherwise provide access permission to the user computing system 122 that requested the access. The access permission can include, for example, cryptographic keys used to generate valid access credentials or decryption keys used to decrypt access credentials. The client computing system 124 can also allocate resources to the target entity and provide a dedicated web address for the allocated resources to the user computing system 122, for example, by adding the user computing system 122 in the access permission. With the obtained access credentials or the dedicated web address, the user computing system 122 can establish a secure network connection to the interactive computing environment 126 hosted by the client computing system 124 and access the resources via invoking API calls, web service calls, HTTP requests, other suitable mechanisms or techniques, etc.

In some examples, the risk assessment computing system 102 may determine whether to grant, challenge, or deny the access request made by the user computing system 122 for accessing the interactive computing environment 126. For example, based on the risk indicator associated with the target entity, the risk assessment computing system 102 can determine that the target entity is a legitimate entity that made the access request and may authenticate the request. In other examples, the risk assessment computing system 102 can challenge or deny the access attempt if the risk assessment computing system 102 determines that the target entity may not be a legitimate entity.

In some examples, the risk indicator used to determine access to the interactive computing environment 126 may be determined at least in part based on output from one or more machine-learning models (e.g., machine-learning models of result analysis module 114). For example, the result analysis module 114 can extract text from the records retrieved from the external data sources 116. The extracted text can include information such as an event date, event type, event description, and the like. The extracted text can be applied to one or more algorithms, e.g., a machine-learning model, to determine a risk indicator based on the event data. The risk indicator can be determined, for example, based on a determination of an event type and a mapping of that event type to a level of risk. The levels of risk associated with multiple events can be combined to determine the risk indicator.

Each communication within the computing environment 100 may occur over one or more data networks, such as a public data network 128, a network 130 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices illustrated in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate may be instead implemented in a signal device or system.

Process for Generating a Risk Indicator Associated with a Target Entity

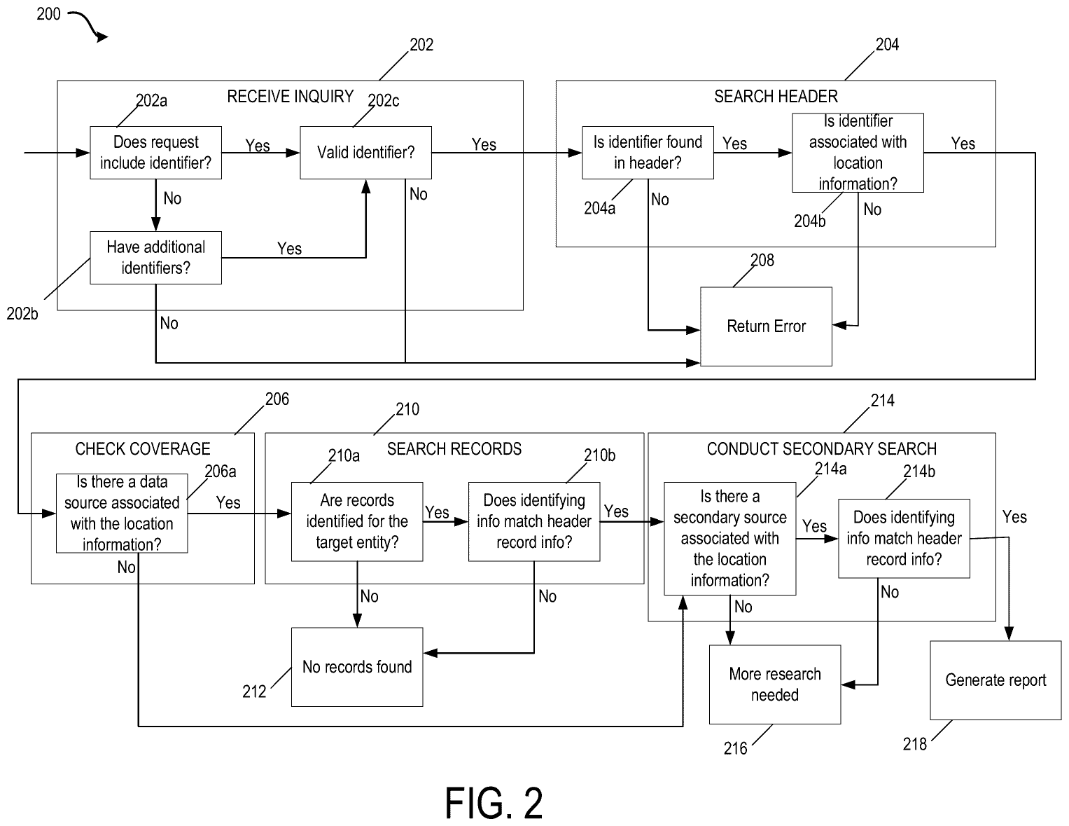

FIG. 2 is a block diagram depicting an example process 200 for generating a risk assessment associated with a target entity according to some aspects of the present disclosure. The process 200 can be implemented by any of the components as described above with reference to FIG. 1. For example, the steps described with respect to FIG. 2 can be executed by the risk assessment server 102 via one or both of public network 128 and network 130. Other implementations or architectures, however, are possible.

At block 202, the process 200 can include receiving an inquiry from a client computing system 124. The inquiry can include an identifier of a target entity. For example, the identifier could be an SSN, a name, a serial number, or any other information that uniquely identifies an entity (e.g., an individual, an organization, or a system). In some examples, the inquiry may be received from the target entity themselves via the user computing system 122. The inquiry can be a request for event data associated with the target entity or a risk indicator generated by the risk assessment computing system 102 that is based on event data associated with the target entity. In some examples, the event data or risk indicator can be used by the client computing system 124 to determine whether to grant or deny access of the target entity to an interactive computing environment 126. For example, a risk indicator can reflect a risk associated with a system based on event data indicating the most recent update to the system's security software. In another example, the risk indicator can reflect the risk associated with an individual based on event data indicating the individual was previously convicted of a crime.

At block 202a, the process 200 can include determining whether the request from the client computing system 124 includes an identifier associated with the target entity. For example, the risk assessment application 106 can receive the request and determine that the request includes a unique identifier associated with the target entity. If the request does not include a unique identifier, at block 202b, the risk assessment application 106 can request additional identifying information associated with the target entity from the client computing system 124. The additional identifying information can be a combination of information associated with the target entity, where the combination of information can uniquely identify the target entity. For example, a combination of identifying information can be a full address, DOB, and mailing address. In another example, a combination of identifying information can be an IP address, device name, and operating system version.

At block 202b, if, in response to the request for additional information, the client computing system 124 does not return additional information (e.g., within a predetermined timeframe), the risk assessment application 106 can return an error at block 208 to the client computing system 124. The error can include, for example, a reason code indicating that the request cannot be processed without additional identifying information associated with the target entity. If the client computing system 124 responds with additional information, the process 200 can proceed to block 202c.

At block 202c, process 200 can include determining, by the risk assessment application 106, whether the unique identifier is valid. For example, for an SSN, the risk assessment application 106 can determine whether the received SSN is in a valid nine-digit format. If the unique identifier is not in a valid format, the risk assessment application 106 can communicate with the client computing system 124 that the request for event data or a risk indicator cannot be processed. If the unique identifier is not valid, at block 208, the risk assessment application 106 can return an error message to the client computing system 124 indicating that the identifier associated with the target entity is invalid.

If the identifier is valid, the process 200 can include, at block 204, searching the data repository for a record containing the unique identifier, e.g., a header record. At block 204a, the header search module 108 of the risk assessment application 106 can query the data repository 118 using the unique identifier received and validated at block 202. The header search module 108 can receive the results of the query. For example, the query can return a record associated with the target entity. The record can include, for example, PII such as a name, a DOB, a current address, and one or more previous addresses of the target entity.

At block 204b, the process 200 can include determining, by the header search module 108, whether the returned record includes locators or location information associated with the target entity. For example, the header search module 108 can extract text data from the header record and parse the extracted text data to identify a locator, such as a ZIP code. In the example of a system component, a locator can be a ZIP code of a data center, or a location (e.g., a rack) within a datacenter. The header search module 108 can pass the identified locator or locators to the database search module 110. If no header records matching the identifier are located, or if the header record does not include any location information, the risk assessment application 106 can return an error at block 208.

At block 206 and 206a, the process 200 can include determining whether there is database coverage for each identified locator. For example, the database search module 110 can receive the locator information associated with the target entity and determine whether there exists a database associated with each identified locator. The database search module 110 can, in some examples, query a database (not shown) of the risk assessment system 102 indicating which external databases (e.g., data sources 116) are accessible to the risk assessment system 102. As an example, the risk assessment system 102 can have access to number of data sources 116, such as county court databases, county public records databases, offender registry lists, and the like. In another example, the data sources 116 can include manufacturer databases associated with the manufacturers of system components of a target system.

In some examples, the database search module 110 can query a mapping table to determine if there are data source 116 associated with the location information of the target entity and if these data sources 116 are accessible to the risk assessment computing system 102. A data source may be inaccessible to the risk assessment computing system 102, for example, if a data source associated with a particular location does not exist or if the risk assessment computing system 102 does not have permissions to access the data source. If a data source associated with one or more of the locations of the target entity is inaccessible, then the database search module 110 can initiate an asynchronous secondary search, which will be described in further detail below.

At block 210, the process 200 can include searching the identified databases for records associated with the target entity based on the identity information included in the header record. At block 210, the risk assessment application 106 will have received a valid identifier, located a record associated with the identifier, and determined that the data sources associated with locations indicated in the header record exist and are accessible to the risk assessment computing system 102. The process 200 can proceed to block 210a in which the database search module 110 queries the identified data sources from data sources 116 using identity information retrieved from the record associated with the target entity. In some examples, the database search module 110 can query data sources 116, prior to retrieving data, to determine that records associated with the target entity exist in one or more of the data sources 116. Thus, if no records associated with the target entity are located, the risk assessment application 106 can return a response indicative of a low risk. If records are located in one or more of the data sources 116, the risk assessment application 106 can return an indication of the potential existence of records associated with the target entity or a preliminary risk indicator such that the requesting system can make a preliminary decision regarding risk while waiting for the records to be retrieved.

At block 210a, the database search module 110 may query each database associated with a locator from the record, e.g., the header record. If information associated with the target entity is identified in any of the databases, the risk assessment application 106 can generate and transmit a message to the client computing system 124 that indicates that no records associated with the target entity were found. If a record is found in one of the databases, the database search module 110 can pass the record to the identity module 112 for verification.

To avoid falsely attributing a record to the target entity, the identity module 112 can determine whether the record is associated with the target entity with a predetermined level of confidence. For example, at block 210b, the process 200 can include determining whether identifying information in the retrieved record matches the identifying information contained in the header record retrieved at block 204a. In some examples, the identity module 112 can extract and analyze data from the retrieved record to generate a set of identifying information associated with the entity described in the retrieved record.

As an example, a record may be retrieved from a database based on a query using the target entity's first and last name. The record may be parsed to retrieve entity identity information contained in the record including a first name, middle name, last name, and DOB of the entity described by the record. The identity module 112 can compare this information with target entity identity information from the header record to confirm whether the entity described in the retrieved record is the target entity. For example, the entity and target entity may have the same first and last name, but different DOB. The identity module 112 can compare the entity identity information and the target entity identity information to determine a level of confidence that the entity is the target entity. The level of confidence can be based on, for example, a degree of matching between one or more identity elements (e.g., first name, middle name, last name, DOB, address, and the like). When the entity identity information has a degree of matching with the target entity identity information that is above a predetermined threshold, the entity can be considered to be the target entity. The risk assessment system 102 can, in some aspects, adjust the predetermined level of confidence depending on a tolerated level of risk indicated by the client computing system 124. If the confidence level is below the predetermined threshold, the risk assessment application 106 can return an indication of no records found, at block 212, to the client computing system 124.

In some examples, if an event record is identified for the target entity, and the confidence level that the entity in the event record is the target entity is above the predetermined threshold, at block 214a, the risk assessment application 106 can determine whether a secondary data source is associated with a location associated with the event record. As an example, the event record could be an offense registry record associated with the target entity and the secondary data source could be an automated court reporting system associated with a location (e.g., a ZIP code of the target entity's current address).

In some examples, prior to searching the secondary data source, the process 200 can include comparing a date associated with an identified event record with a date threshold. For example, if the date the event took place is older than a predetermined threshold (e.g., seven years), then the event record may be discarded. In such example, the risk assessment application 106 can return, to the client computing system 124, an indication that no records associated with the target entity were found. Additional qualitative or quantitative filters can be implemented to remove records from the search. For example, based on text analysis, the risk assessment application 106 may discard event records associated with events of a certain type.

Returning to the secondary search at block 214, the risk assessment application 106, e.g., using the database search module 110, that a secondary data source (e.g., one of data sources 116) associated with a location of the target entity and the event record is accessible to the risk assessment computing system 102. The risk assessment application 106 can access query the secondary data source via an API to search for records associated with the event record. For example, the risk assessment application 106 can query the secondary data source based on target entity identity information and event information such as an event date and event type. In another example, the risk assessment application 106 can access and search the secondary data source using a bot or other program configured to login to a system associated with the secondary data source and search the secondary data source.

If no records associated with the event are located, or if no secondary data source is accessible to the risk assessment computing system 102, the process 200, at block 216, can transmit a responsive message to the client computing system 124 indicating that additional research into the event and target entity is required and that a risk indicator cannot be generated. If a record associated with the event is located in the secondary data source, the process 200, at block 214b, can include determining whether information identifying the entity associated with the event matches identifying information of the target entity. As discussed above, this can include extracting and analyzing text or other data from the located record. For example, the risk assessment application 106 can determine a degree of matching between the information identifying the entity associated with the event and identifying information of the target entity. In other examples, the risk assessment application 106 can determine a confidence level the entity described in the record is the target entity based on identifying information of the target entity and identifying information of the entity in the record.

If the confidence level or degree of matching is greater than a predetermined threshold, the process 200 can include block 218, in which the risk assessment application 106 generates a report including the information retrieved from the first data source and the secondary data source. An exemplary report can include a set of one or more events identified by querying one or more data sources associated with locations of the target entity. The report can include event details, such as an event type, event date, event outcome, and event description that are retrieved from the data source or the secondary data source.

In some examples, the report can also include a risk indicator associated with the target entity. The risk indicator can be determined by the result analysis module 114 based on the set of event data retrieved from the data sources. For example, using an algorithm such as a machine-learning model or NLP model, the risk assessment application 106 can determine a risk indicator. The risk indicator may be based on, for example, a mapping of event types to an associated level of risk or severity depending on the target entity's role in the event. The algorithm can, for example, extract text from retrieved event data and can identify key words or phrases that map to varying levels of severity. The levels of severity identified for key words or phrases in the extracted text can be combined to generate a risk indicator for the entity based on the event data. In another example, the risk indicator can be based on the recency of the event, outcome of the event (e.g., whether the target entity was convicted), type of event, or other information (e.g., if the target entity is an individual, the age of the target entity when the event occurred). The output risk indicator can be used by the client computing system 124 to determine whether to grant or deny access of the target entity to the interactive computing environment 126. For example, if the risk indicator is greater than a risk tolerance threshold, the client computing system 124 can deny access to the interactive computing environment 126 to the target entity.

If, at block 214b, the degree of confidence that the entity of the event record is the target entity is below the confidence threshold, the risk assessment application 106 can, at block 216, return a responsive message to the client computing system 124 indicating that further research into the target entity is required to determine a risk indicator. Such a responsive message may cause the client computing system 124 to issue a temporary denial of access to the interactive computing environment 126 to the target entity until additional steps are taken.

As an example of the process 200, the risk assessment computing system 102 can receive, from a client computing system 124, a request for a risk indicator associated with a target entity. The request can include an SSN (e.g., an identifier) associated with the target entity. The risk assessment application 106 can be used by the risk assessment computing system 102 to determine the risk indicator for the target entity. The risk assessment application 106 can query an internal database (e.g., the data repository 118) to identify a header record associated with the target entity based on the target entity's SSN. The header record can include identifying information, such as PII including a name, DOB, and one or more addresses associated with the target entity (e.g., a current address and one or more previous addresses.

In this example, the header record associated with the target entity can include a name, a DOB, a first address (i.e., the target entity's current address), a second address, and a third address. Each address can include location information, such as a ZIP code. Thus, the target entity can be associated with a first ZIP code, a second ZIP code, and a third ZIP code. Data sources 116 can include databases associated with ZIP code, or with other geographic areas. For example, a database can be associated with a county that is made up of multiple ZIP codes.

The risk assessment application 106 can query an internal database or mapping table to identify whether databases associated with each of the first, second, and third ZIP codes exist. If databases exist for jurisdictions associated with the three ZIP codes, the risk assessment application 106 can proceed to query each database using the identifying information included in the retrieved header record. If no records associated with the identifying information are located in the three databases, the risk assessment computing system 102 can return a responsive message to the client computing system 124 indicating that no records associated with target entity were found.

In an alternative example, if databases exist for jurisdictions associated with the first and second ZIP codes, but not the third ZIP code, the risk assessment computing system 102 can generate a responsive message indicating that more research into the target entity is needed and transmit this message to the client computing system 124. In this example, neither database associated with the first or second ZIP code is searched, thereby preserving computing power and returning a result more efficiently that can be acted upon by the client computing system 124.

Returning to the example in which databases for the three ZIP codes exist, the risk assessment application 106 can query each database. As an example, the database associated with the first ZIP code may contain an event record associated with the target entity. The event record can describe an entity associated with the event and can include identifying information associated with the entity. The risk assessment application 106 can compare the identifying information of the entity described in the event record with identifying information associated with the target entity to determine whether the entity described in the event record is the target entity.

If the risk assessment application 106 determined that the entity is the target entity with a degree of confidence above a confidence threshold, the risk assessment application 106 may determine (e.g., by querying a mapping table) whether a secondary data source associated with the first ZIP code is available to the risk assessment computing system 102. If a secondary data source is available, the risk assessment application 106 can query, via an API, the secondary source using the event data from the event record and the identifying information of the target entity. The risk assessment application 106 can analyze any returned event records from the secondary data source to generate a risk indicator. The risk assessment application 106 can generate a report including the risk indicator and the retrieved information associated with the event and can transmit the report to the client computing system 124. The client computing system 124 can then use the risk indicator to determine whether to grant or deny access by the target entity to the interactive computing environment 126.

Techniques for Generating a Risk Indicator Associated with a Target Entity

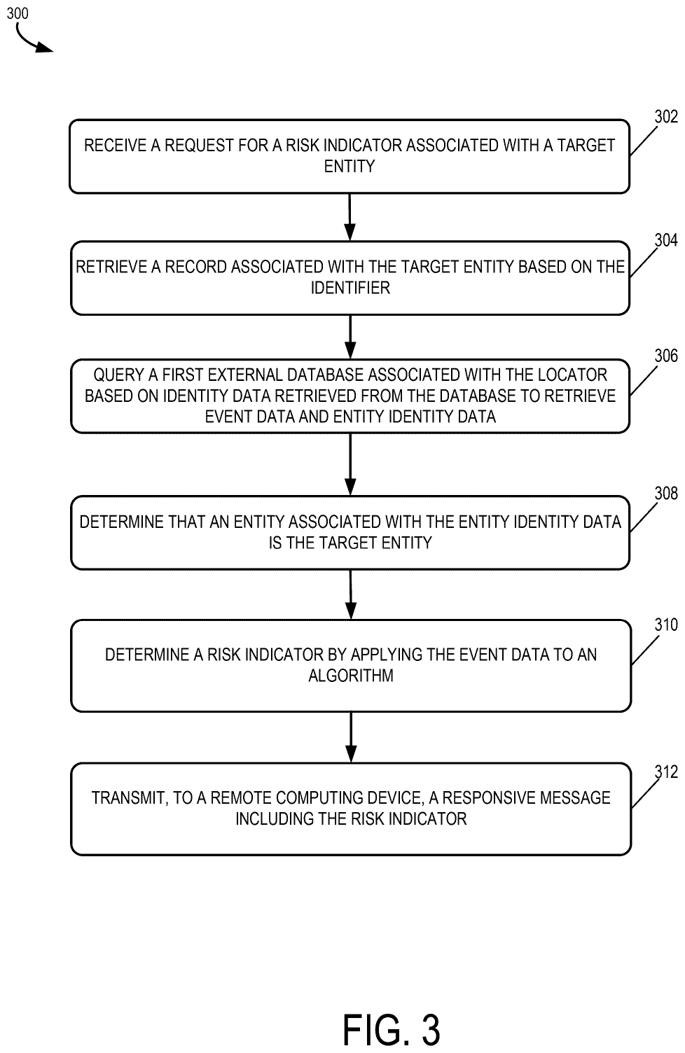

FIG. 3 is a flow chart illustrating an example of a process 300 for generating a risk assessment associated with a target entity according to some aspects of the present disclosure. In some examples, the operations of the process 300, or any subset thereof, may be performed by the risk assessment computing system 102 via the risk assessment server 104, but other suitable systems, devices, or subsets or combinations thereof may perform one or more operations described with respect to the process 300. For illustrative purposes, the process 300 is described with reference to certain examples depicted in the figures. Other implementations, however, are possible.

At block 302, the process 300 involves receiving a request for a risk indicator associated with a target entity. The request can include an identifier associated with the target entity. The identifier can be, for example, PII such as an SSN, or a combination of PII such as a name and DOB. The request may be generated as part of an authentication process initiated when the target entity attempts to access an interactive computing environment 126.

At block 304, the process 300 involves retrieving, by the risk assessment application 106 from a database (e.g., data repository 118), a record associated with the target entity based on the identifier. The record can, in some aspects, be a header record storing identity information or PII associated with the identifier. The record can include a locator and identity data. For example, a locator may be a ZIP code associated with an address of the target entity. In some examples, a target entity may be associated with several ZIP codes, e.g., if the target entity is associated with a current address and one or more previous addresses.

At block 306, the process 300 involves, querying, by the risk assessment application 106 via an API, a first external database (e.g., a data source of data sources 116) associated with the locator based on the identity data to retrieve one or more records. The one or more records can be event records including event data (e.g., an event type and event date) and information identifying the entity associated with the event. In some examples, the risk assessment application 106 can generate a query based on a mapping of header record fields to fields available in the first external database.

At block 308, the process 300 involves determining, by the risk assessment application 106, that an entity associated with the entity identity data is the target entity by comparing the entity identity data and the identity data associated with the target entity. For example, the risk assessment application 106 can determine a degree of matching between the identity data or a level of confidence that the target entity is the entity of the event record. If the degree of matching or level of confidence is greater than a confidence threshold, the event record can be associated with the target entity (i.e., the entity described in the event record is the target entity).

At block 310, the process 300 involves determining, by the risk assessment application 106, a risk indicator by applying the event data to an algorithm based on the determination that the entity is the target entity. As discussed above, the risk indicator can be determined by NLP or by a machine-learning model configured to output a risk indicator based on input data such as an event date, event type, event description, and the like, as well as information associated with the target entity. In some examples, each event type can be assigned a weight based on a level of severity associated with the event type. A weight may also be based on the recency of the event or the role of the target entity in the event.

At block 312, the process 400 involves transmitting, to a remote computing device (e.g., the client computing device 124), a responsive message comprising at least the risk indicator for use in controlling access of the target entity to one or more interactive computing environments. For example, the risk indicator can be used in controlling an interaction involving a target entity or access of the target entity to a restricted system (e.g., the interactive computing environment 126).

Systems and methods described herein provide advantages over traditional event or background screening systems. For example, described systems and methods can provide screening results more efficiently by determining, prior to searching each source, whether a source is not accessible to the system and cannot be searched. By providing this result immediately, the requesting system can take immediate action, while the system conducts an asynchronous search of any accessible databases. In some examples, the risk assessment system 102 can provide an explorable risk indicator, allowing a user to review data associated with any identified events associated with the target entity. Additionally, by incorporating data from a set of data sources, the risk assessment system 102 can generate a more accurate and dependable risk indicator.

### Example of Computing System

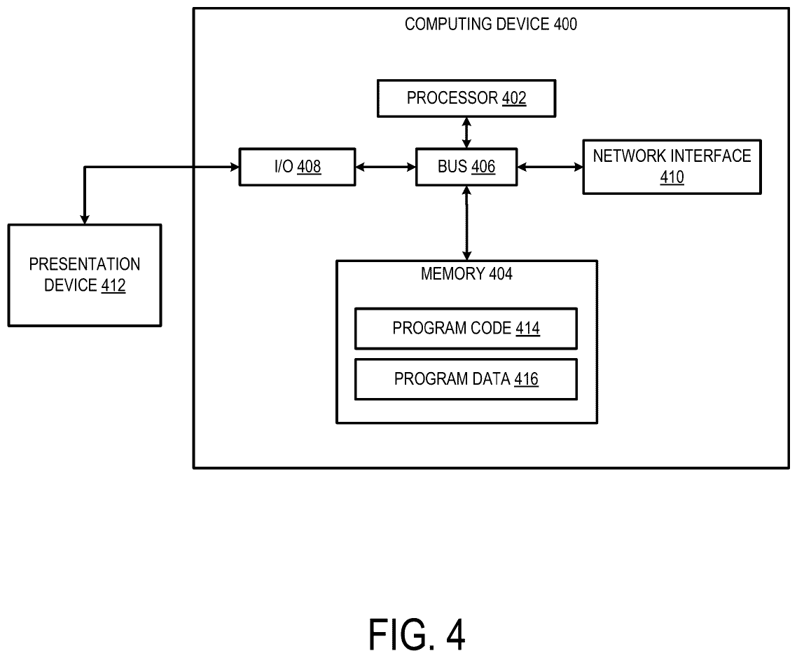

Any suitable computing system or group of computing systems can be used to perform the operations for the techniques described herein. For example, FIG. 4 is a block diagram depicting an example of a computing device 400, which can be used to implement the risk assessment server 104. The computing device 400 can include various devices for communicating with other devices in the computing environment 100, as described with respect to FIG. 1. The computing device 400 can include various devices for performing one or more operations, such as risk assessment operations, described above with respect to FIGS. 1-3.

The computing device 400 can include a processor 402 that can be communicatively coupled to a memory 404. The processor 402 can execute computer-executable program code stored in the memory 404, can access information stored in the memory 404, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 402 can include a microprocessor, an application-specific integrated circuit (ASIC), a field-programmable gate array (FPGA), or any other suitable processing device. The processor 402 can include any suitable number of processing devices, including one. The processor 402 can include or communicate with a memory 504. The memory 404 can store program code that, when executed by the processor 402, causes the processor 402 to perform the operations described herein.

The memory 404 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C #, Visual Basic, Java, Python, Perl, JavaScript, ActionScript, etc.

The computing device 400 may also include a number of external or internal devices such as input or output devices. For example, the computing device 400 is illustrated with an input/output interface 408 that can receive input from input devices or provide output to output devices. A bus 406 can also be included in the computing device 400. The bus 406 can communicatively couple one or more components of the computing device 400.

The computing device 400 can execute program code 414 that can include risk assessment application 106. The program code 414 for the risk assessment application 106 may be resident in any suitable computer-readable medium and may be executed on any suitable processing device. For example, and as illustrated in FIG. 4, the program code 414 for the risk assessment application 106 can reside in the memory 404 at the computing device 400 along with the program data 416 associated with the program code 414. Executing the risk assessment application 106 can configure the processor 402 to perform at least a portion of the operations described herein.

In some aspects, the computing device 400 can include one or more output devices. One example of an output device can be or include the network interface device 410 illustrated in FIG. 4. A network interface device 410 can include any device or group of devices suitable for establishing a wired or wireless data connection to one or more data networks described herein. Non-limiting examples of the network interface device 410 can include an Ethernet network adapter, a modem, etc.

Another example of an output device can include the presentation device 412 depicted in FIG. 4. A presentation device 412 can include any device or group of devices suitable for providing visual, auditory, or other suitable sensory output. Non-limiting examples of the presentation device 412 can include a touchscreen, a monitor, a speaker, a separate mobile computing device, etc. In some aspects, the presentation device 412 can include a remote client-computing device that communicates with the computing device 400 using one or more data networks described herein. In other aspects, the presentation device 412 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A computer-implemented method comprising:
receiving, by a processor, a request for a risk indicator associated with a target entity, wherein the target entity is associated with an identifier;
retrieving, by the processor from a database, a record associated with the target entity based on the identifier, wherein the record comprises a locator and identity data;
querying, by the processor via an application programming interface, a first external database associated with the locator based on the identity data to retrieve one or more records comprising first event data and entity identity data;
determining, by the processor, that an entity associated with the entity identity data is the target entity by comparing the entity identity data and the identity data associated with the target entity;
determining, by the processor, a risk indicator by applying the event data to an algorithm based on the determination that the entity is the target entity; and
transmitting, by the processor to a remote computing device, a responsive message comprising at least the risk indicator to control access of the target entity to one or more interactive computing environments.

2. The method of claim 1, wherein determining that the entity associated with the entity identity is the target entity further comprises:
determining, by the processor, a confidence level associated with a degree of matching between the entity identity data and the identity data associated with the target entity; and
determining, by the processor, that the confidence level is greater than a confidence threshold.

3. The method of claim 1, wherein determining the risk indicator comprises:
extracting, by the processor, text data from the event data;
parsing, by the processor, the text data to identify at least one keyword; and
mapping, by the processor, the at least one keyword to a level of risk in a mapping table, wherein the level of risk is used at least in part in determining the risk indicator.

4. The method of claim 1, further comprising:
generating, by the processor, a report comprising the risk indicator and the event data; and
including, by the processor, the report in the responsive message such that information in the report can be used to control access of the target entity to one or more interactive computing environments.

5. The method of claim 1, further comprising:
generating, by the processor, a query for the first external database by mapping the identity data to one or more fields of the first external database.

6. The method of claim 1, further comprising:
identifying, by the processor, a second external database associated with the locator;
querying, by the processor via an application programming interface, the second external database based on the identity data to retrieve one or more records comprising second event data and second entity identity data;
determining, by the processor, that a second entity associated with the second entity identity data is the target entity by comparing the second entity identity data and the identity data associated with the target entity; and
determining, by the processor, the risk indicator based at least in part on the second event data.

7. The method of claim 6, wherein determining that the second entity associated with the second entity identity data is the target entity further comprises:
determining, by the processor, that the second entity is the target entity based on a confidence level associated with a degree of matching between the second entity identity data and the identity data associated with the target entity being above a confidence threshold.

8. The method of claim 1, further comprising:
determining, by the processor, an age of the first event data; and
including, by the processor, the first event data in the responsive message based on the age being less than a record age threshold.

9. The method of claim 1, further comprising:
identifying, by the processor, one or more databases associated with the locator, wherein the one or more databases comprises the first external database.

10. The method of claim 9, further comprising:
identifying, by the processor, a third external database of the one or more databases that is not accessible to the processor; and
including, by the processor in the responsive message, an indication that the third external database is not accessible.

11. A system comprising:
a processor; and
a non-transitory computer-readable medium comprising instructions that are executable by the processor for causing the processor to perform operations comprising:
receiving a request for a risk indicator associated with a target entity, wherein the target entity is associated with an identifier;
retrieving, from a database, a record associated with the target entity based on the identifier, wherein the record comprises a locator and identity data;
querying, via an application programming interface, a first external database associated with the locator based on the identity data to retrieve one or more records comprising first event data and entity identity data;
determining that an entity associated with the entity identity data is the target entity by comparing the entity identity data and the identity data associated with the target entity;
determining a risk indicator by applying the event data to an algorithm based on the determination that the entity is the target entity; and
transmitting, to a remote computing device, a responsive message comprising at least the risk indicator for use in controlling access of the target entity to one or more interactive computing environments.

12. The system of claim 11, wherein the operation of determining that an entity associated with the entity identity data is the target entity further comprises:
determining that the entity is the target entity based on a confidence level associated with a degree of matching between the entity identity data and the identity data associated with the target entity; and
determining that the confidence level is greater than a confidence threshold.

13. The system of claim 11, wherein the operation of determining the risk indicator further comprises:
extracting text data from the event data;
parsing the text data to identify at least one keyword; and
mapping the at least one keyword to a level of risk in a mapping table, wherein the level of risk is used at least in part in determining the risk indicator.

14. The system of claim 11, wherein the operations further comprise:
generating a report comprising the risk indicator and the event data; and
including the report in the responsive message such that information in the report can be used to control access of the target entity to one or more interactive computing environments.

15. The system of claim 11, wherein the operations further comprise:
generating a query for the first external database by mapping the identity data to one or more fields of the first external database.

16. A non-transitory computer-readable storage medium having program code that is executable by a processor device to cause a computing device to perform operations, the operations comprising:
receiving a request for a risk indicator associated with a target entity, wherein the target entity is associated with an identifier;
retrieving, from a database, a record associated with the target entity based on the identifier, wherein the record comprises a locator and identity data;
querying, via an application programming interface, a first external database associated with the locator based on the identity data to determine whether the first external database contains records associated with the target entity;
determining a preliminary risk indicator based on the determination that records associated with the target entity exist in the first external database; and
transmitting, to a remote computing device, a first responsive message comprising at least the preliminary risk indicator for use in controlling access of the target entity to one or more interactive computing environments.

17. The non-transitory computer-readable storage medium of claim 16, wherein the operations further comprise:
retrieving one or more records from the first external database, wherein the one or ore records comprise first event data and entity identity data;
determining that an entity associated with the entity identity data is the target entity by comparing the entity identity data and the identity data associated with the target entity;
determining a risk indicator by applying the event data to an algorithm based on the determination that the entity is the target entity; and
transmitting, to the remote computing device, a second responsive message comprising at least the risk indicator for use in controlling access of the target entity to one or more interactive computing environments.

18. The non-transitory computer-readable storage medium of claim 17, wherein the operation of determining that an entity associated with the entity identity data is the target entity further comprises:
determining that the entity is the target entity based on a confidence level associated with a degree of matching between the entity identity data and the identity data associated with the target entity; and
determining that the confidence level is greater than a confidence threshold.

19. The non-transitory computer-readable storage medium of claim 17, wherein the operation of determining the risk indicator further comprises:
extracting text data from the event data;
parsing the text data to identify at least one keyword; and
mapping the at least one keyword to a level of risk in a mapping table, wherein the level of risk is used at least in part in determining the risk indicator.

20. The non-transitory computer-readable storage medium of claim 17, wherein the operations further comprise:
generating a report comprising the risk indicator and the event data; and
including the report in the responsive message such that information in the report can be used to control access of the target entity to one or more interactive computing environments.
